(19) United States
(12) Patent Application Publication
(10) Pub. No.: US 2015/0355049 A1
(43) Pub. Date: Dec. 10, 2015

(54) DETERMINATION OF A LEAKAGE RATE OF AN INSULATION GAS

(71) Applicant: ALSTOM TECHNOLOGY LTD, Baden (CH)

(72) Inventors: Farid AIT ABDELMALEK, AIX LES BAINS (FR); Jean-Luc RAYON, MONTANAY (FR); Wilfrid WEIDMANN, LA BIOLLE (FR)

(73) Assignee: ALSTOM TECHNOLOGY LTD, BADEN (CH)

(21) Appl. No.: 14/761,922

(22) PCT Filed: Jan. 20, 2014
(86) PCT No.: PCT/EP2014/051010

§ 371 Date: Jul. 17, 2015

(30) Foreign Application Priority Data
Jan. 22, 2013 (FR) 13 50556

(51) Int. Cl. G01M 3/32; G01N 9/00; G01F 1/00; H02B 13/035; H02B 13/065

(52) U.S. Cl. CPC G01M 3/3272; H02B 13/035; H02B 13/0655; G01F 1/00; G01N 9/00

(57) ABSTRACT

A method of determining a leak rate of an insulating gas from a gas-insulated compartment of an electrical installation having a plurality of similar compartments, the method being characterized in that it comprises the steps of;
periodically determining a gas density for each of the compartments;
determining respective straight lines from series of gas densities for each of the compartments;
comparing slopes of the determined lines with one another;
detecting a leak if the result of a comparison for one of the slopes is greater than a threshold; and in the event of a leak being detected
determining a leak rate for the compartment associated with the slope that lead to a leak being detected.

### TECHNICAL FIELD

The present invention relates to monitoring high-voltage equipment using a gas with high dielectric potential.

More particularly, the present invention relates to determining a leak rate of insulating gas from a gas-insulated compartment of an electrical system.

In order to protect the environment, release of insulating gas such as sulfur hexafluoride SF₆ must be controlled. Sulfur hexafluoride SF₆ is one of the greenhouse gases targeted by the Kyoto protocol as well as in Directive 2003/87/EC. Its global warming potential (GWP) is 22,800 times greater than that of carbon dioxide CO₂.

The leak rate of an insulating gas from a high-voltage installation of the gas-insulated switchgear (GIS)/gas-insulated line (GIL) type must therefore be monitored.

### STATE OF THE PRIOR ART

It is known to use density monitors having contacts on a GIS. Those electro-mechanical devices are calibrated to activate at pressure values set by the manufacturer of the GIS. They make it possible to give a state of dielectric strength of the switchgear, but in no event do they make it possible to be informed about the amount of gas lost, or the gas leak rate.

Analog sensors/transmitters of gas density, also called densimeters, may be used in order to measure and transmit a magnitude representative of the insulating gas density enclosed in a compartment of the GIS, but they are sensitive to the electromagnetic disturbances caused by the high-voltage environment of the installation.

Said densimeters make it possible to deduce trend curves, but with accuracy of only a few percent. That accuracy is not sufficient for monitoring the leak rate of insulating gas from an installation of the GIS/GIL type.

It is possible to observe an SF₆ gas leak with an infrared camera. However, that does not make it possible to quantify the quantity of gas lost.

Assuming that a compartment of SF₆ gas that is leaking needs to be filled from a container of SF₆ gas, it is also possible to weigh the container before and after each top-up in order to deduce the quantity lost since the last top-up and thus deduce the leak rate. However, several years may separate two top-ups. Between two top-ups, no information is available about the leak rate of the gas.

### SUMMARY OF THE INVENTION

The invention aims to overcome the problems of the prior art by providing a method of determining a leak rate of an insulating gas from a gas-insulated GIS compartment of an electrical installation having a plurality of similar compartments;

the method being characterized in that it comprises the steps of:
periodically determining a gas density value for each of the compartments of the installation;
determining respective trend lines from series of gas density values that have previously been determined for each of the compartments of the installation;
comparing slopes of the determined trend lines with one another;
detecting a leak if the result of a comparison for one of the slopes is greater than a predetermined threshold; and in the event of a leak being detected for a slope
determining a leak rate for the compartment associated with the slope that lead to a leak being detected.

By means of the invention, it is possible to determine the leak rate of insulating gas, in such a manner as to guarantee that it remains below a contractual value and/or to alert an operator in the event of a leak. The leak rate is determined as a function of the slopes associated with the compartments of the installation.

According to a preferred characteristic, the periodic determination of a gas density value for each of the compartments of the installation comprises determining an instantaneous density of the gas present in each compartment from pressure and temperature measurements and calculating a mean of the instantaneous densities considered over a predetermined period.

Thus, the calculations are made over a certain duration that is selected as a function of the progression of possible insulating gas leaks and as a function of ambient temperature variations and of the profile of the load. In general, these are relatively slow phenomena.

According to a preferred characteristic, the respective trend lines are determined in a moving window over the series of gas density values. Each new gas density determined for a compartment contributes to the series of values and thus causes updating of the calculation of the slope of the trend line under consideration.

That makes it possible to follow the progression of the gas density values.

According to a preferred characteristic, the slopes of the trend lines are compared when a change in slope is detected for one of the compartments.

When there is a drift in the slope of a trend line relative to the other trend lines in a bounded observation window then a leak of insulating gas is suspected.

The change of slope of a trend line marks the end of an observation window in which the slopes linked to a plurality of similar compartments are compared and a leak rate is calculated.

A change of slope may be caused by thermal variations in the surrounding air giving rise to movements of gas inside its casing or by the appearance of a leak in a compartment.

According to a preferred characteristic, comparison of the slopes of the trend lines comprises comparing each of the slopes with the mean of the other slopes in order to determine an offset for each slope.

Thus, each trend line recorded for a compartment is compared with the other trend lines of similar compartments, and that makes it possible to detect a potential behavior that is different from one of the compartments.

According to a preferred characteristic, detection of a leak comprises selecting the largest offset in absolute value and comparing the selected offset with the predetermined threshold.

The offset thus selected corresponds to the compartment for which a leak is declared if the offset is greater than the predetermined threshold.

According to a preferred characteristic, the leak rate is determined from the largest selected offset.

The invention further provides a device for determining a leak rate of an insulating gas from a gas-insulated compartment of an electrical system having a plurality of similar compartments;

the device being characterized in that it comprises:
means for periodically determining a gas density value for each of the compartments of the installation;
means for determining respective trend lines from series of gas density values that have previously been determined for each of the compartments of the installation;
means for comparing slopes of the determined trend lines with one another;
means for detecting a leak if the result of a comparison for one of the slopes is greater than a predetermined threshold; and in the event of a leak being detected for a slope
means for determining a leak rate for the compartment associated with the slope that lead to a leak being detected.

The invention further provides an electrical installation including a device as presented above.

The device and the installation present advantages similar to those presented above.

In a particular implementation, the steps of the method of the invention are performed by computer program instructions.

Consequently, the invention also relates to a computer program on a data medium, said program being suitable for running on a computer, said program comprising instructions for performing the steps of a method as described above.

The program may use any programming language, and may be in the form of source code, object code, or code intermediate between source code and object code, such as in a partially compiled form, or in any other desirable form.

The invention also provides a data medium that is readable by a computer, and comprising computer program instructions that are adapted to implementing steps of a method as described above.

The data medium may be any entity or device capable of storing the program. By way of example, the data medium may comprise storage means, such as a read-only memory (ROM), e.g. a compact disk (CD) ROM, or a microelectronic ROM, or even magnetic recording means, e.g. a floppy disk or a hard disk.

In addition, the data medium may be a transmittable medium such as an electrical, optical, or electromagnetic signal, suitable for being conveyed via an electrical or optical cable, by radio, by electromagnetic waveguide, or by other methods. The program of the invention may in particular be downloaded over an Internet type network.

Alternatively, the data medium may be an integrated circuit in which the program is incorporated, the circuit being adapted to execute or to be used in the execution of the method of the invention.

### BRIEF DESCRIPTION OF THE DRAWINGS

Other characteristics and advantages appear on reading the following description of preferred embodiments given by way of non-limiting example and with reference to the figures, in which:

FIG. 1a is a diagram of a first high-voltage electrical installation having gas-insulated compartments, and fitted with a device for determining a leak rate of an insulating gas from a gas-insulated compartment in a first embodiment of the invention;

FIG. 1b is a diagram of a second high-voltage electrical installation having gas-insulated compartments, and fitted with a device for determining a leak rate of an insulating gas from a gas-insulated compartment in a second embodiment of the invention;

FIG. 2 represents a method of determining a leak rate of an insulating gas from a gas-insulated compartment of the invention;

FIG. 3 shows substeps of the method of FIG. 2; and

FIG. 4 shows trend lines determined according to the invention.

### DETAILED DESCRIPTION OF PARTICULAR EMBODIMENTS

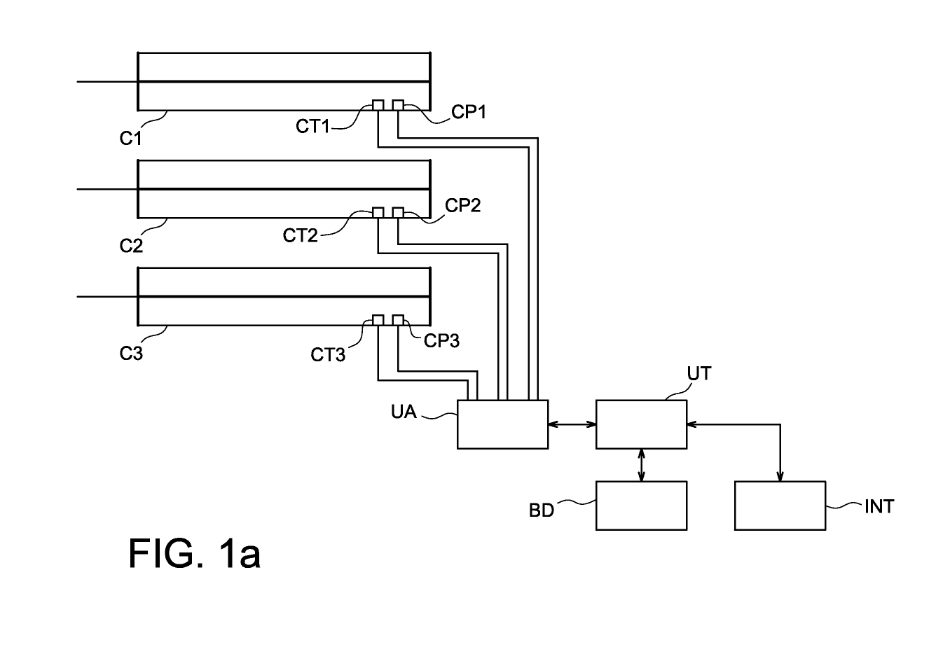

In a first preferred embodiment shown in FIG. 1a, a three-phase electrical installation comprises gas-insulated compartments C1, C2, and C3, each corresponding to an electrical phase of the installation.

The three compartments C1, C2, and C3 are of similar constitution, size, and volume. The length of a compartment may be of a few tens of centimeters up to a few tens of meters. The compartments have one or more conductors passing through them and in which a current may potentially flow. Each compartment has a metal casing filled with a gas under pressure and presenting dielectric properties in order to ensure electrical insulation of the conductor of the casing. Each compartment has its ends closed by insulating and leaktight barriers. By way of example, the insulating gas is sulfur hexafluoride SF₆.

Temperature sensors CT1, CT2, and CT3 and pressure sensors CP1, CP2, and CP3 are fitted respectively in each compartment C1, C2, and C3, in order to measure the temperature and the pressure of the insulating gas. The temperature and pressure sensors are distinct or they are encapsulated within a single transmitter. Each sensor has a respective microprocessor and communicates in digital manner with an acquisition unit UA, that is itself connected to a data processor unit UT. The acquisition unit may be remote or it may be encapsulated in the transmitter. Each temperature and pressure sensor has an output connected to an input of the acquisition unit UA, which unit has an output connected to an input of the data processor unit UT.

It should be observed that the invention may be implemented with density transmitters, or density monitors.

The data processor unit UT handles the measurements and how they are used, as described below.

The data processor unit UT is connected to a database BD that stores all the calculated and measured data. The data processor unit is also connected to a man-machine interface INT that may in particular inform an operator in the event of a leak being detected.

FIG. 1b shows a second embodiment of the electrical installation that comprises gas-insulated compartments. In this embodiment, the installation is not a three-phase installation, but a single-phase installation.

This installation generally comprises the same elements as those of the first embodiment. For reasons of simplification, the same references designate similar elements.

The single-phase electrical installation thus includes three compartments C1, C2, and C3 that have one or more conductors successively passing through them and in which a current may potentially pass.

It should be observed that the number of compartments may be different.

Temperature sensors CT1, CT2, and CT3 and pressure sensors CP1, CP2, and CP3 are fitted respectively in each compartment C1, C2, and C3, in order to measure the temperature and the pressure of the insulating gas.

Each temperature and pressure sensor has an output connected to an input of an acquisition unit UA, which unit has an output connected to an input of a data processor unit UT.

The data processor unit UT is connected to a database BD. The data processor unit UT is also connected to a man-machine interface INT.

The operation of these elements and their interactions are similar in both embodiments. The remainder of the description therefore applies equally well to either embodiment.

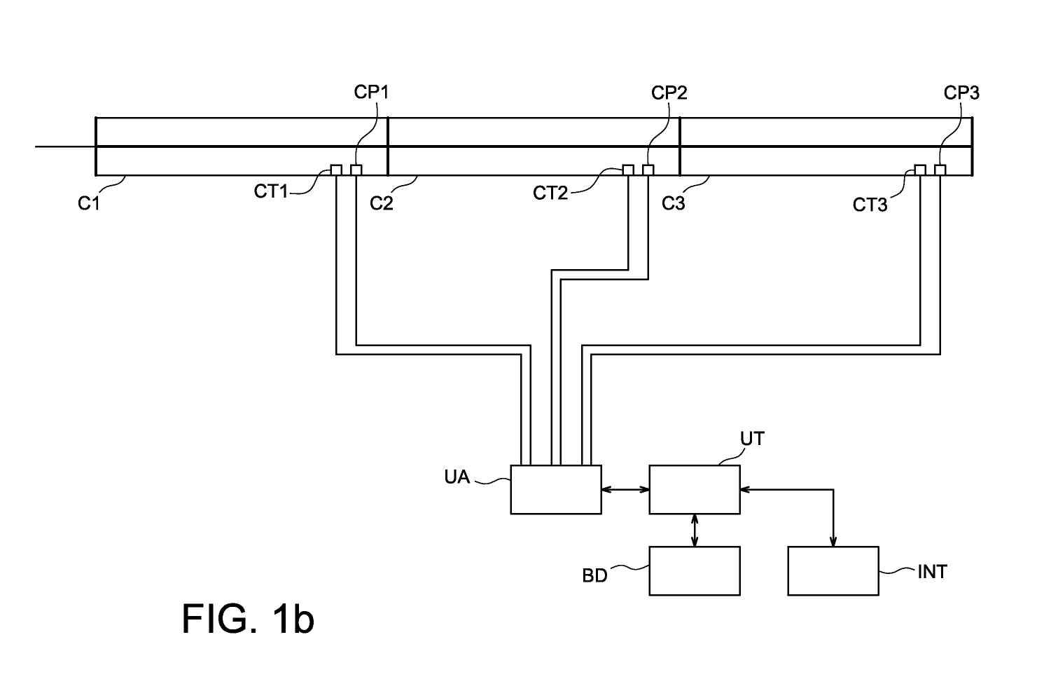

FIG. 2 shows the operation of the device of the invention, in the form of a method comprising steps E1 to E8.

In the invention, the unit UT primarily implements the following steps:
periodically determining a gas density value for each of the compartments of the installation;
determining respective trend lines from series of gas density values that have previously been determined for each of the compartments of the installation;
comparing slopes of the determined trend lines with one another;
detecting a leak if the result of a comparison for one of the slopes is greater than a predetermined threshold; and in the event of a leak being detected for a slope
determining a leak rate for the compartment associated with the slope that lead to a leak being detected.

More precisely, the step E1 is a step in which the respective gas pressures P1, P2, and P3 and temperatures T1, T2, and T3 are measured in each of the compartments C1, C2, and C3. The measurements are performed periodically, with a period that may be configured by the user. These measurements are typically performed several times per second.

The following step E2 is a filtering step in order to eliminate anomalous measurements and retain only values that are consistent.

The following step E3 is a step of determining the respective gas density values D1, D2, and D3 for each of the compartments C1, C2, and C3 of the installation.

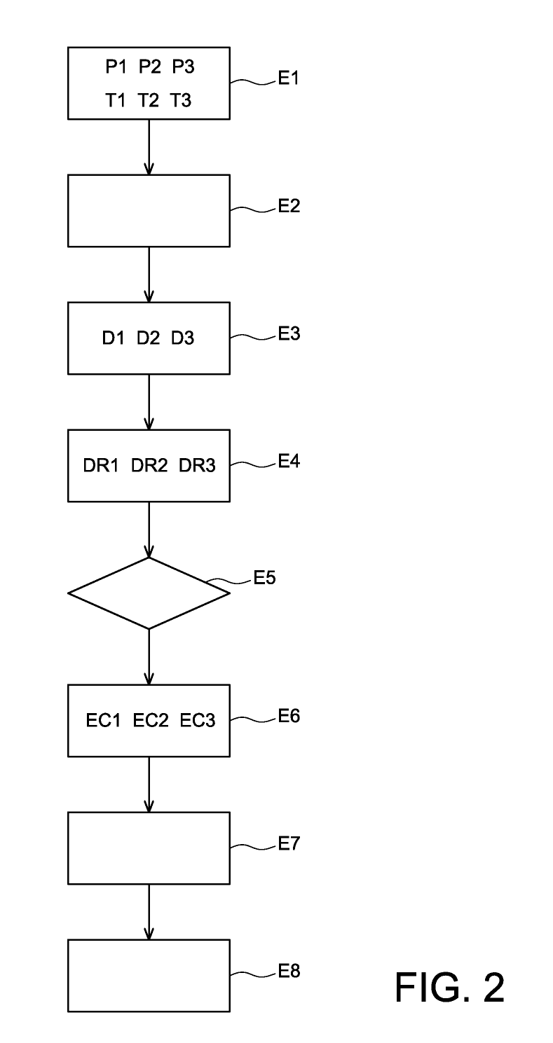

Step E3 comprises substeps E31 to E33 described with reference to FIG. 3.

In step E31, a mean of the pressures MP1 to MP3 and a mean of the temperatures MT1 to MT3 are calculated respectively for each of the compartments C1 to C3. The means are calculated for a predetermined number of measured values. The pressure means are calculated periodically with a period that may be configurable by the user.

At the following step E32, an instantaneous density DI1 to DI3 of the gas present in each compartment C1 to C3 is determined respectively from the previously calculated mean pressure and temperature values by using the Beattie-Bridgeman (real gas) equation of state. This calculation is performed periodically, e.g. every 2 seconds.

The following step E33 is calculating for each compartment C1 to C3 a mean of the instantaneous densities DI1 to DI3 considered over a predetermined period presenting the lowest thermal amplitude in the surrounding air and the lowest load amplitude i.e. the lowest amplitude for current transiting through the conductors.

The mean of the instantaneous densities for each compartment C1 to C3 is thus the result of step E3 in the form of a gas density value D1 to D3. This gas density is stored in the database BD, which database thus contains a series of daily gas density values for each compartment C1 to C3. Naturally, the measured values and the results of the intermediate calculations are also stored.

Step E3 is followed by step E4 that is a step of determining a trend line, by linear regression over the series of gas density values D1 to D3 determined in step E3, for each of the compartments C1 to C3. Each compartment is therefore associated with a trend line. Determining a trend line includes determining its slope.

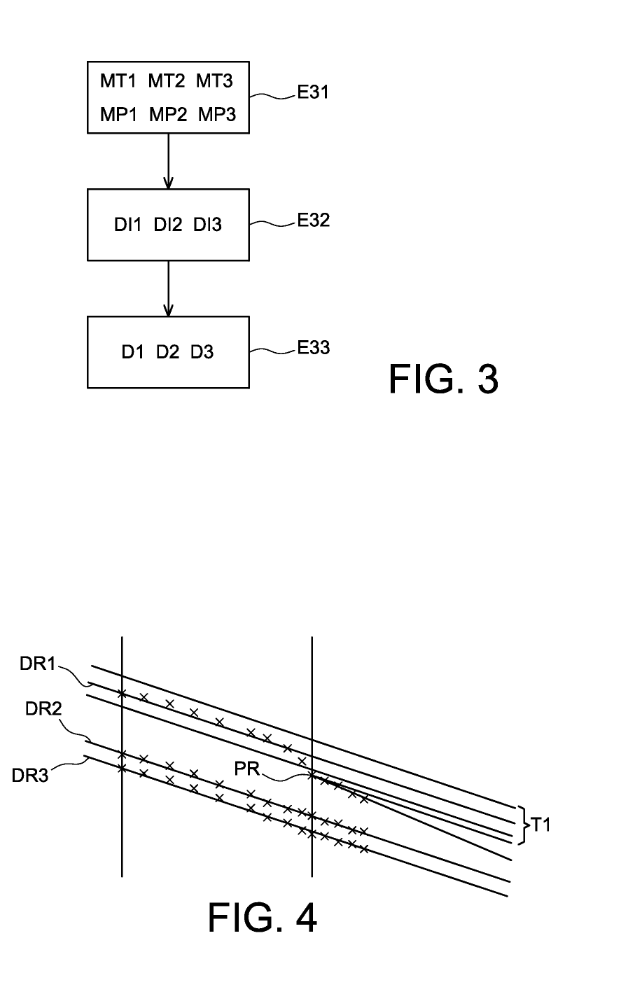

FIG. 4 shows three trend lines DR1, DR2, and DR3, determined from gas density D1, D2, and D3 series. A given trend line corresponds to a given compartment.

Trend lines are calculated in a moving window. The size of the window is determined as a function of variations in ambient temperature, of the load profile, i.e. the amplitude of current flowing in the installation, and of detecting a discontinuity in the slope, as explained below.

By way of example, the observation window for a GIS situated in a location fitted with air-conditioning is shorter than that for a GIS situated outdoors or in a location subjected to high thermal amplitudes.

A margin of uncertainty is established about each calculated trend line, by applying Student's t-distribution with a given level of confidence. By way of example, a single margin T1 is shown about the line DR1 in FIG. 4.

The following step E5 is a test to determine whether there is a discontinuity in the slope of one of the trend lines. A discontinuity is detected when there is a change in slope over a plurality of values, and when these values are outside the margin of uncertainty. Such a discontinuity in the slope is shown in FIG. 4: on the trend line DR1, from the discontinuity point PR, the density values determined for the compartment C1 are outside the margin T1.

This discontinuity point PR marks the boundary of the observation window in progress and initiates a new window.

When there is a discontinuity in the slope, the step E5 is followed by the step E6 at which the slop of the trend lines DR1, DR2, and DR3 of the previous window are compared with one another. For that, each slope is compared with the mean of the two others, which results in respective offsets EC1, EC2, and EC3 for each trend line DR1, DR2, and DR3. The offset having the greatest absolute value is retained.

In the following step E7, the offset retained is compared with a predetermined threshold. If the offset retained is greater than the predetermined threshold, a leak is declared for the compartment for which the offset has been retained.

The following step E8 is the calculation of the leak rate of the compartment for which a leak has been declared for the above-described step. The leak rate is calculated as a function of the offset retained from step E6 for said compartment. Since the volumes of the compartments are known, it is possible to determine the quantity of gas lost. The leak rate is the quantity of gas lost per unit of time.

In order to determine a leak rate over a legal or contractual time period, it is possible to cumulate a plurality of observation windows.

If no leak is detected over a plurality of successive and closed moving windows, the windows may be juxtaposed in order to perform a new leak rate calculation over a longer period by calculating a mean slope across the juxtaposed windows.

It is possible to inform the operator of different events that are measured or calculated through the man-machine interface INT.

The calculated leak rate may be compared with the legal or contractual obligations that determine a maximum leak rate, e.g. 0.5% per year for a complete GIS.

1. A method of determining a leak rate of an insulating gas from a gas-insulated compartment of an electrical installation having a plurality of similar compartments;
the method comprising the steps of:
periodically determining a gas density value for each of the compartments of the installation;
determining respective trend lines from series of gas density values that have previously been determined for each of the compartments of the installation;
comparing slopes of the determined trend lines with one another;
detecting a leak if the result of a comparison for one of the slopes is greater than a predetermined threshold; and in the event of a leak being detected for a slope
determining a leak rate for the compartment associated with the slope that lead to a leak being detected.

2. A determination method according to claim 1, wherein the periodical determination of a gas density value for each of the compartments of the installation comprises determining an instantaneous density of the gas present in each compartment from the pressure and temperature measurements and the calculation of a mean of the instantaneous densities considered over a predetermined period.

3. A determination method according to claim 1, wherein the respective trend lines are determined in a moving window over the series of gas density values.

4. A determination method according to claim 1, wherein the slopes of the trend lines are compared when a change in slope is detected for one of the compartments.

5. A determination method according to claim 1, wherein the comparison of the slopes of the trend lines comprises comparing each of the slopes with the mean of the other slopes in order to determine an offset for each slope.

6. A determination method according to claim 5, wherein detection of a leak comprises selecting the largest offset in absolute value and comparing the selected offset with the predetermined threshold.

7. A determination method according to claim 6, wherein the leak rate is determined from the largest selected offset.

8. A device for determining a leak rate of an insulating gas from a gas-insulated compartment of an electrical installation having a plurality of similar compartments;
the device comprising:
means for periodically determining a gas density value for each of the compartments of the installation;
means for determining respective trend lines from series of gas density values that have previously been determined for each of the compartments of the installation;
means for comparing slopes of the determined trend lines with one another;
means for detecting a leak if the result of a comparison for one of the slopes is greater than a predetermined threshold; and in the event of a leak being detected for a slope; and
means for determining a leak rate for the compartment associated with the slope that lead to a leak being detected.

9. An electrical installation device comprising:
means for periodically determining a gas density value for each of the compartments of the installation;
means for determining respective trend lines from series of gas density values that have previously been determined for each of the compartments of the installation;
means for comparing slopes of the determined trend lines with one another;
means for detecting a leak if the result of a comparison for one of the slopes is greater than a predetermined threshold; and in the event of a leak being detected for a slope; and
means for determining a leak rate for the compartment associated with the slope that lead to a leak being detected.

10. An electrical installation according to claim 9, which is multi-phased and in that each compartment corresponds to a phase of the installation.

11.-12. (canceled)
